(19) United States
(12) Patent Application Publication
(10) Pub. No.: US 2020/0091667 A1
(43) Pub. Date: Mar. 19, 2020

(54) USB CONNECTOR COMBINATION WITH ATTACHABLE PLUG

(71) Applicant: Oxti Corporation, Taipei (TW)

(72) Inventor: Chih Feng HO, Taipei (TW)

(21) Appl. No.: 16/294,999

(22) Filed: Mar. 7, 2019

(30) Foreign Application Priority Data
Sep. 14, 2018 (TW) 107212552

(51) Int. Cl. H01R 31/06; H01R 13/516

(52) U.S. Cl. CPC H01R 31/06; H01R 13/516

(57) ABSTRACT

A USB connector combination includes a cable having an end portion, a plug member attached to the end portion of the cable, and a plug element attached to the cable with a gripping member for preventing the plug element from being separated from the plug member and the cable inadvertently when the plug element is disengaged from the plug member. The plug member and the plug element each include an updateable connector tip, and the plug element includes a receiver orifice for receiving and engaging with the updateable connector tip of the plug member. The plug element is preferably coupled to the gripping member with an arm.

### BACKGROUND OF THE INVENTION

### 1. Field of the Invention

The present invention relates to a universal serial bus (USB) connector combination, and more particularly to a USB connector combination including an additional plug of different type for detachably or changeably attached to the USB connector and for preventing the additional plug from being disengaged or separated from the USB connector inadvertently.

### 2. Description of the Prior Art

Typical universal serial bus (USB) connectors comprise a wire or cable, and one or more terminals or conductors or plugs attached or mounted or secured or coupled to the cable for connecting or coupling to various electrical apparatuses or facilities, such as personal computers, notebooks, docks, discs, mobile phones, portable phones, etc., and the plugs are selected from type A, type B, type C, or the like for connecting or coupling to the selected or predetermined or required electrical apparatuses or facilities.

For example, the type A terminals or conductors or plugs may be provided for connecting or coupling to the personal computers, notebooks or the like, and the type C terminals or conductors or plugs may be provided for connecting or coupling to the docks, discs, mobile phones, portable phones, etc., and may not be provided for connecting or coupling to the other or different types of electrical apparatuses or facilities. Normally, two or more different types of terminals or conductors or plugs are required to be provided and carried with the user.

For example, U.S. Pat. No. 9,231,344 B1 to Liao, U.S. Pat. No. 9,431,746 B2 to Wu et al. disclose two of the typical USB connectors for connecting or coupling to various electrical apparatuses or facilities, but the typical USB connectors may be provided and used for connecting or coupling to only one type of the electrical apparatuses or facilities, but may not be provided for connecting or coupling to the other or different types of electrical apparatuses or facilities.

U.S. Pat. No. 9,270,038 B1 to Chao, and U.S. Pat. No. 9,455,528 B1 to Chao disclose the other two of the typical USB connectors each comprising two or more terminals or conductors or plugs for connecting or coupling to the other or different types of electrical apparatuses or facilities.

However, the typical USB connectors may comprise two or more wires or cables for connecting or coupling to different types of the terminals or conductors or plugs, and may comprise a large volume and/or a complicated structure or configuration that may not be easily carried with the user.

The present invention has arisen to mitigate and/or obviate the afore-described disadvantages of the conventional USB connectors or terminals.

### SUMMARY OF THE INVENTION

The primary objective of the present invention is to provide a USB connector combination including an additional plug of different type for detachably or changeably attached to the USB connector and for preventing the additional plug from being disengaged or separated from the USB connector inadvertently.

In accordance with one aspect of the invention, there is provided a USB connector combination comprising a cable including an end portion, a plug member attached to the end portion of the cable, and a plug element attached to the cable with a gripping member for preventing the plug element from being separated from the plug member and the cable inadvertently when the plug element is disengaged from the plug member.

The plug member includes an updateable connector tip extended outwardly from the plug member. The plug element includes an updateable connector tip extended outwardly from the plug element, and a receiver orifice formed in the plug element for receiving and engaging with the updateable connector tip of the plug member.

The plug element is coupled to the gripping member with an arm. The gripping member is selected from either a C-shaped structure or a U-shaped structure.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a USB connector combination in accordance with the present invention;

FIG. 2 is another perspective view similar to FIG. 1, illustrating the operation of the USB connector combination;

FIG. 3 is a partial exploded view illustrating the other arrangement of the USB connector combination;

FIG. 4 is a further perspective view illustrating the USB connector combination as shown in FIG. 3; and

FIG. 5 is a still further perspective view similar to FIGS. 1 and 4, illustrating the further arrangement of the USB connector combination.

### DETAILED DESCRIPTION OF THE PREFERRED EMBODIMENT

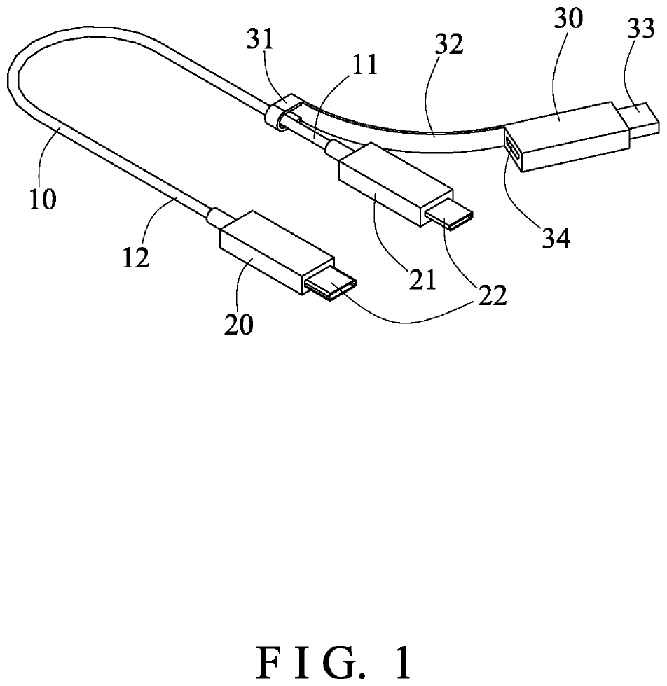

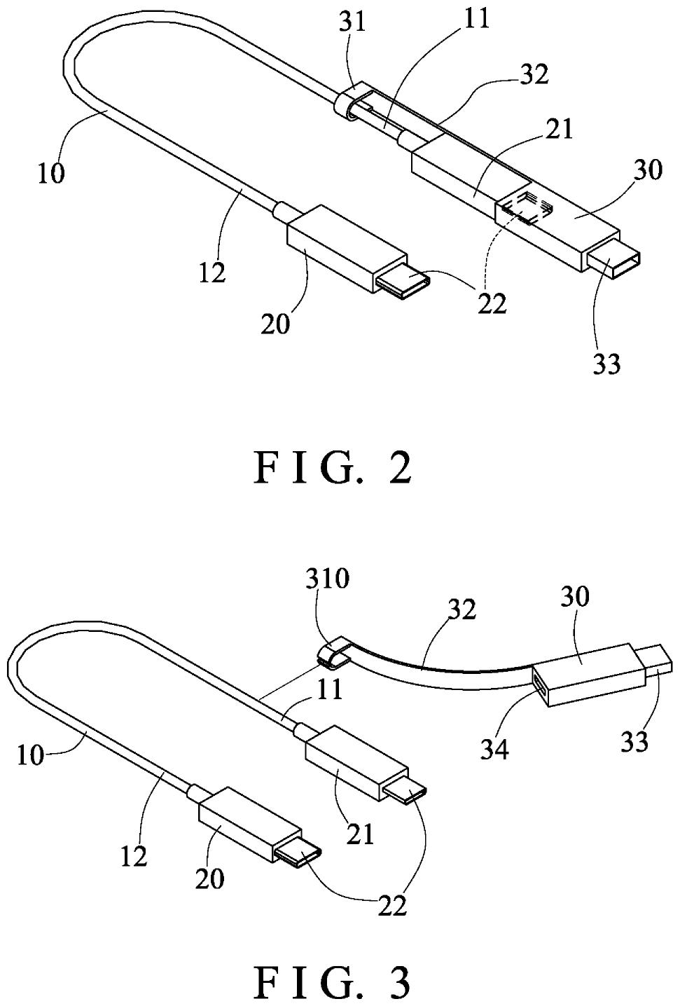

Referring to the drawings, and initially to FIGS. 1 and 2, a USB connector assembly or combination in accordance with the present invention comprises a wire or cable 10 including one or more (such as two) end portions 11, 12, such as one or first end portion 11, and the other or second end portion 12, and one or more (such as two) terminals or conductors or plug members 20, 21 attached or mounted or secured or coupled to the end portions 11, 12 of the cable 10 for connecting or coupling to various electrical apparatuses or facilities (not illustrated), such as personal computers, notebooks, docks, discs, mobile phones, portable phones, etc.

The plug members 20, 21 may be selected from type A, type B, type C, or the like for connecting or coupling to various electrical apparatuses or facilities (not illustrated), such as personal computers, notebooks, docks, discs, mobile phones, portable phones, etc. For example, the plug members 20, 21 may be selected from type A or type B, or type C for connecting or coupling to the docks, discs, mobile phones, portable phones, etc., and the plug members 20, 21 each include an updateable connector tip 22 extended outwardly therefrom. The above-described structure or configuration for the updateable connector tip 22 extended from the plug member 20, 21 is typical and is not related to the present invention and will not be described in further details.

The USB connector assembly or combination in accordance with the present invention further comprises an additional plug element 30 of different type for detachably or changeably attaching to the USB connector combination and for preventing the additional plug element 30 from being disengaged or separated from the USB connector combination inadvertently. For example, the additional plug element 30 may be selected from type B, or type C, or type A for connecting or coupling to the personal computers, notebooks or the like, and may be detachably or changeably attached to the cable 10 with a hooking or gripping member 31, and the additional plug element 30 may be attached or mounted or secured or coupled to the gripping member 31 with a bar or spring arm 32 or the like.

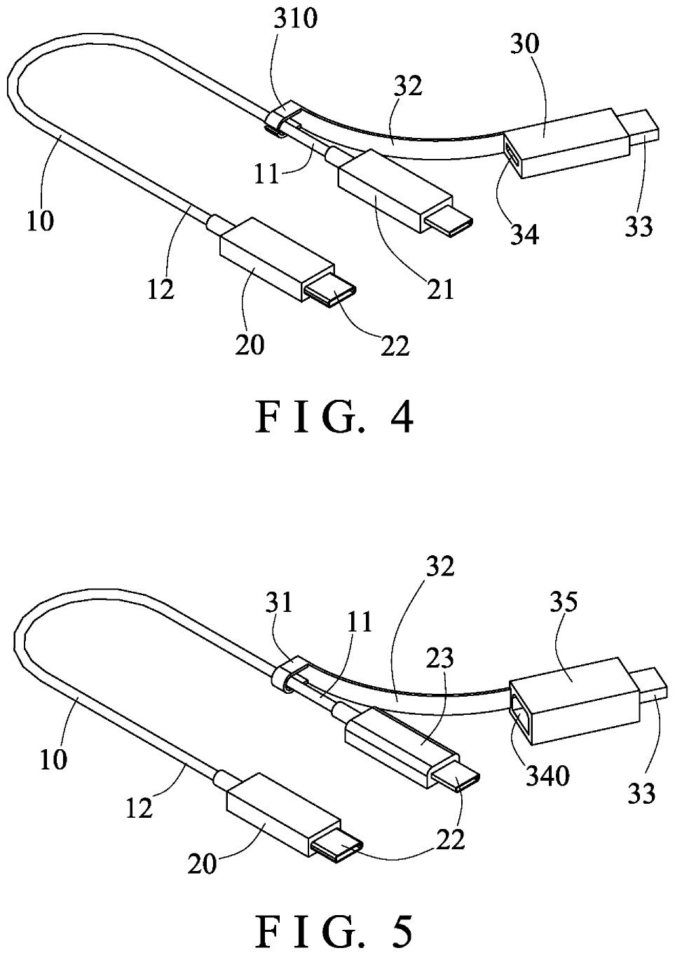

For example, as shown in FIGS. 1-2 and 5, the gripping member 31 may be selected from a C-shaped structure or configuration for detachably or changeably attaching to the cable 10; or alternatively, as shown in FIGS. 3-4, the gripping member 310 may be selected from a U-shaped structure or configuration for detachably or changeably attaching to the cable 10. The additional plug element 30 also includes an updateable connector tip 33 extended outwardly therefrom, and further includes a receiver orifice 34 formed therein for receiving or engaging with the updateable connector tip 22 of either of the plug members 20, 21, best shown in FIG. 2. It is to be noted that the additional plug element 30 may still be attached or coupled to the cable 10 with the gripping member 31 when the additional plug element 30 is disengaged or separated from either of the plug members 20, 21, best shown in FIG. 1.

As shown in FIG. 5, the plug 23 of different type may be selectively attached or mounted or secured or coupled to either of the end portions 11, 12 of the cable 10, and the plug 35 of different type may include a different receiver orifice 340 formed therein for receiving or engaging with the plug 23 selectively.

In operation, as shown in FIG. 1, when the plug element 30 is disengaged or separated from either of the plug members 20, 21, the plug element 30 may still be attached or coupled to the cable 10 with the gripping member 31 and will not be disengaged or separated from the cable 10; and the plug element 30 may be easily and quickly and readily attached to or engaged with either of the plug members 20, 21 (FIG. 2) when required.

Accordingly, the USB connector combination in accordance with the present invention includes an additional plug of different type for detachably or changeably attached to the USB connector and for preventing the additional plug from being disengaged or separated from the USB connector inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A USB connector combination comprising:
a cable including an end portion,
a plug member attached to said end portion of said cable, and
a plug element attached to said cable with a gripping member.

2. The USB connector as claimed in claim 1, wherein said plug member includes an updateable connector tip extended outwardly from said plug member.

3. The USB connector as claimed in claim 2, wherein said plug element includes a receiver orifice formed in said plug element for receiving and engaging with said updateable connector tip of said plug member.

4. The USB connector as claimed in claim 1, wherein said plug element is coupled to said gripping member with an arm.

5. The USB connector as claimed in claim 1, wherein said gripping member is selected from either a C-shaped structure or a U-shaped structure.

6. The USB connector as claimed in claim 1, wherein said plug element includes an updateable connector tip extended outwardly from said plug element.

7. A USB connector combination comprising:
a cable including a first end portion and a second end portion,
a first and a second plug members attached to said first and said second end portions of said cable respectively, and
a plug element attached to said cable with a gripping member.

8. The USB connector as claimed in claim 7, wherein said plug element includes a receiver orifice formed in said plug element, and said first and said second plug members each include an updateable connector tip for engaging with said receiver orifice of said plug element selectively.

9. The USB connector as claimed in claim 7, wherein said plug element is coupled to said gripping member with an arm.

10. The USB connector as claimed in claim 7, wherein said gripping member is selected from either a C-shaped structure or a U-shaped structure.

11. The USB connector as claimed in claim 7, wherein said plug element includes an updateable connector tip extended outwardly from said plug element.
